(19) United States
(12) Patent Application Publication
(10) Pub. No.: US 2016/0125007 A1
(43) Pub. Date: May 5, 2016

(54) METHOD OF FINDING COMMON SUBSEQUENCES IN A SET OF TWO OR MORE COMPONENT SEQUENCES

(71) Applicant: Richard Salisbury, Austin, TX (US)

(72) Inventor: Richard Salisbury, Austin, TX (US)

(21) Appl. No.: 14/924,425

(22) Filed: Oct. 27, 2015

Related U.S. Application Data
(60) Provisional application No. 62/073,128, filed on Oct. 31, 2014.
(60) Provisional application No. 62/083,842, filed on Nov. 24, 2014.
(60) Provisional application No. 62/170,095, filed on Jun. 2, 2015.

(51) Int. Cl. G06F 17/30

(52) U.S. Cl. CPC G06F 17/30333

(57) ABSTRACT

A method of finding common subsequences in a set of two or more component sequences. The method includes obtaining two or more component sequences and identifying the location(s) of one or more distinct items that occur at least once within each of the two or more component sequences. The method also includes placing the location(s) within each component sequence of each commonly-occurring distinct item in a location n-tuple and storing each location n-tuple in a location n-tuple container. The method further includes sorting the entries in the location n-tuple container and placing each of the location n-tuples in the location n-tuple container into a tier in a tier set. The method additionally includes obtaining any desired information regarding common subsequences.

### CROSS-REFERENCE TO RELATED APPLICATIONS

This application claims the benefit of and priority to U.S. Provisional Patent Application Ser. No. 62/073,128 filed on Oct. 31, 2014, which application is incorporated herein by reference in its entirety.

This application claims the benefit of and priority to U.S. Provisional Patent Application Ser. No. 62/083,842 filed on Nov. 24, 2014, which application is incorporated herein by reference in its entirety.

This application claims the benefit of and priority to U.S. Provisional Patent Application Ser. No. 62/170,095 filed on Jun. 2, 2015, which application is incorporated herein by reference in its entirety.

### BACKGROUND OF THE INVENTION

The longest common subsequence problem is the problem of finding the longest subsequence common to all sequences in a set of sequences (at least two but possibly more sequences, each a “component sequence”). It differs from problems of finding common substrings: unlike substrings, subsequences are not required to occupy consecutive positions within the original sequences.

A common subsequence of two or more sequences each consisting of one or more items is defined as a sequence of items that appears in each of the component sequences in the same order in each component sequence. The longest common subsequence is defined as the set of one or more common subsequences that have the greatest length. The numerous practical applications for, and desirability of efficiently deriving, a longest common subsequence are well documented in the literature.

However, a need has arisen for means for obtaining not only the longest common subsequence, but the set of one or more common subsequences. A need has also arisen for means for obtaining the set of one or more common subsequences that are of at least a certain minimum length. A need has also arisen for means for obtaining the set of one or more common subsequences that are of at least a certain minimum density. A need has also arisen for means for obtaining the set of one or more common subsequences that are of at least a certain minimum length and a certain minimum density.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of finding common subsequences in a set of two or more component sequences. The method includes obtaining two or more component sequences and identifying the location(s) of one or more distinct items that occur at least once within each of the two or more component sequences. The method also includes placing the location(s) within each component sequence of each commonly-occurring distinct item in a location n-tuple and storing each location n-tuple in a location n-tuple container. The method further includes sorting the entries in the location n-tuple container and placing each of the location n-tuples in the location n-tuple container into a tier in a tier set. The method additionally includes obtaining any desired information regarding common subsequences.

Another example embodiment includes a method of finding common subsequences in a set of two or more component sequences. The method includes obtaining two or more component sequences and identifying the location(s) of one or more distinct items that occur at least once within each of the two or more component sequences. Identifying the location(s) of one or more distinct items that occur at least once within each of the two or more component sequences includes iteratively identifying each item within the component sequence and placing a new entry for the item in a location index associated with the component sequence when the item has not been encountered previously in the component sequence. Identifying the location(s) of one or more distinct items that occur at least once within each of the two or more component sequences also includes adding the current location of the item to an existing entry for the item in a location index associated with the component sequence when the item has been encountered previously in the component sequence. The method also includes adding one or more location indexes associated with one or more component sequences to a location index set and using the location index set to identify the locations of one or more distinct items that occur at least once within each of the two or more component sequences. The method moreover includes placing the location(s) within each component sequence of each commonly-occurring distinct item in a location n-tuple and storing each location n-tuple in a location n-tuple container. The method further includes sorting the entries in the location n-tuple container and placing each of the location n-tuples in the location n-tuple container into a tier in a tier set. The method additionally includes obtaining any desired information regarding common subsequences.

Another example embodiment includes a method of placing a location n-tuple into a tier in a tier set. The method includes creating a new tier, placing the location n-tuple into the newly-created tier and adding the newly-created tier to the tier set when the tier set is empty and determining the correct tier for the location n-tuple when the tier set is not empty. The method also includes placing the location n-tuple into the correct tier.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flow chart illustrating a method of obtaining one or more common subsequences among an arbitrary number of sequences;

FIG. 2 is a flow chart illustrating a method of identifying one or more distinct items and their locations within a component sequence;

FIG. 3 is a flow chart illustrating a method of placing a location n-tuple into a tier in a tier set; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

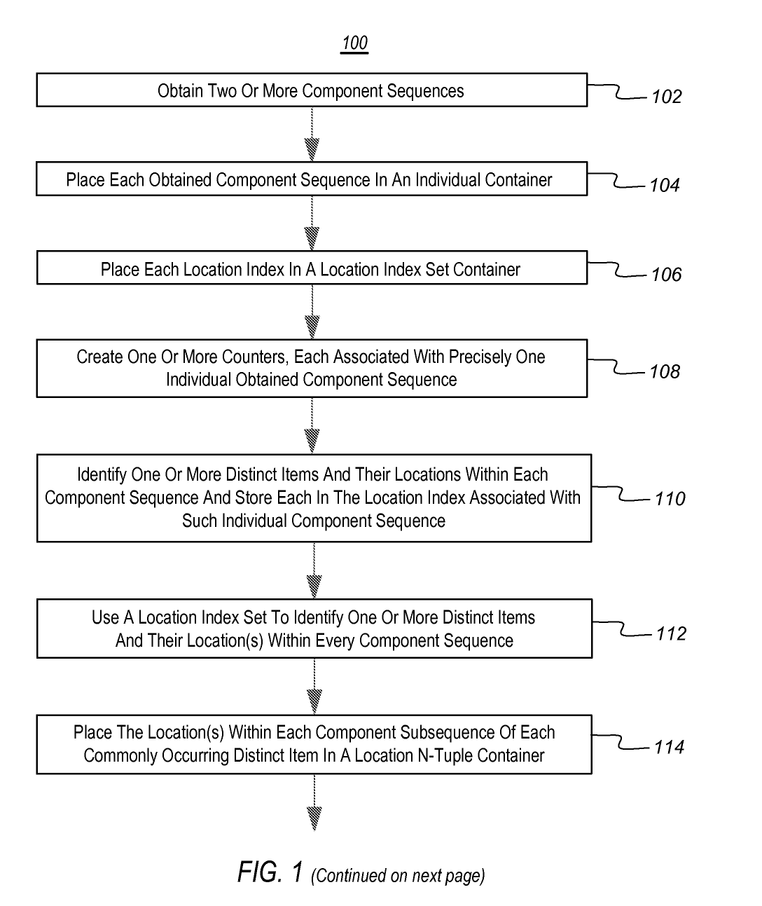

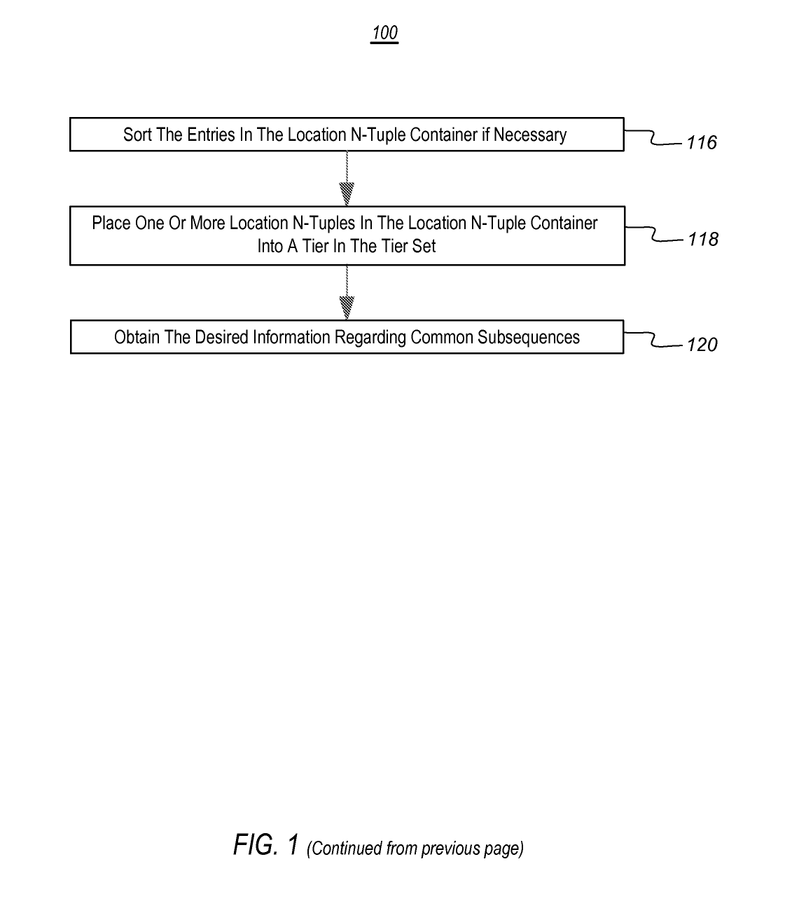

FIG. 1 is a flow chart illustrating a method 100 of obtaining one or more common subsequences among an arbitrary number of component sequences. A sequence is an ordered collection of items in which repetitions are allowed (like a set, it contains members—also called elements, objects, or terms). The items can include any subset of the sequence. For example, if the sequence is a paragraph, the items can be defined as sentences, words, letters, characters or any other subset of the paragraph. The number of elements (possibly infinite) is called the length of the sequence. Unlike a set, order matters, and exactly the same elements can appear multiple times at different positions in the sequence. Formally, a sequence can be defined as a function whose domain is a countable totally ordered set, such as the natural numbers.

A subsequence is a sequence that can be derived from another sequence by deleting some elements without changing the order of the remaining elements. For example, the sequence {A, B, D} is a subsequence of {A, B, C, D, E, F}. A subsequence should not be confused with a substring, which is a refinement of the definition of subsequence that includes the additional requirement that elements in the substring must occupy consecutive positions within the underlying string. For example, {A, B, C, D} is a substring of the string {A, B, C, D, E, F}.

FIG. 1 shows that the method 100 can include obtaining 102 two or more component sequences. The component sequences are sequences for which the common subsequence(s) will be identified. That is, the component sequences are sequences which will be analyzed to identify one or more common subsequences. The number of component sequences must be at least two, since they are to be compared against one another; however, the number can be any number greater than two and common subsequences may still be identified.

FIG. 1 also shows that the method 100 can include placing 104 each obtained 102 component sequence in an individual container (each a “locations index”). A “container” is any form or combination of computer storage capable of containing one or more pieces of data and may include vectors, arrays, linked lists, queues, stacks, trees and hash tables of arbitrary size and/or number of fields or dimensions and may be ordered, unordered or partially ordered. One of skill in the art will appreciate that a container may include other containers and/or may be included within other containers.

FIG. 1 further shows that the method 100 can include placing 106 each locations index in a locations index set. One or more locations indexes may be added to the locations index set. That is, the locations index set is a collection of one or more locations indexes, whereas a locations index is a container which references only locations within a single component sequence.

FIG. 1 additionally shows that the method 100 can include creating 108 one or more counters (each an “item counter”) each associated with precisely one individual obtained 102 component sequence (i.e., each component sequence may be assigned its own item counter). The term “associated with” means any form or combination of computer storage by which one or more pieces of data may be associated with any one or more other pieces of data. The item counter serves to identify the location within the component sequence at which an item occurs. That is, the item counter allows the location of each item within a particular component sequence to be recorded.

FIG. 1 moreover shows that the method 100 can include identifying 110 one or more distinct items and their location(s) within each of one or more individual component sequences and storing each in a location index associated with such individual component sequence. In particular, each such distinct item is stored within a container and the location of each such item is ascertained and retained. Because an item can be found within a component sequence at more than one location each location is retained. For example, in the sequence {A, A, B, C, E, H} the location of item “A” is both position 0 and position 1.

FIG. 1 also shows that the method 100 can include using 112 a location index set to identify the location of one or more distinct items that occur at least once within every component sequence. In particular, any common item that is found in each locations index within the locations index set may be identified. Such common items must be identified because only if an item is common to each component sequence may it be part of any common subsequence. That is, only items that occur at least once within each component sequence may be part of any common subsequence (although they need not necessarily be, as shown below).

FIG. 1 further shows that the method 100 can include placing 114 the location(s) within each component sequence of each commonly-occurring distinct item in a location n-tuple. Each location n-tuple may be stored within a location n-tuple container. However, the item itself is not stored within the location n-tuple, only its location(s) since any common subsequence must have each of the items in the same order in each component sequence and since the item may be identified if the location in one or more of the component sequences is known. For example, if the item “J” occurs in one component sequence at location 7 and in another component sequence at locations 11 and 15, the location n-tuples that may be generated from this combination of locations are {7, 11} and {7, 15}. Likewise, a count of common items may be kept and used in any desired analysis. Using the example above, the count of common items would only be incremented by one because “J” is the only common item, even though multiple location n-tuples have been created. If an analysis is being performed to find a common subsequence above a minimum length then the number of common items must be greater than or equal to the minimum length, otherwise no common subsequence above the minimum length can possibly exist.

FIG. 1 further shows that the method 100 can include sorting 116 the entries in the location n-tuple container, if necessary. For example, the location n-tuple container can be sorted 116 such that the entries are in non-decreasing order with respect to the values appearing in the same component field of each location n-tuple (“location n-tuple sorted order”). The location n-tuple container may be sorted 116 by consistently using the same component field in each location n-tuple as the primary basis of pairwise comparison between two location n-tuples and optionally using one or more other component fields as secondary, tertiary or even further subordinated contingent bases of pairwise comparison. For example, the primary basis for sorting 116 the entries in the location n-tuple container could be the location in the first of the component sequences.

FIG. 1 additionally shows that the method 100 can include placing 118 each of the location n-tuples in the location n-tuple container into a container (each a “tier”) in a container (a “tier set” or “tiers set”). In particular, each location n-tuple (each successively the “current location n-tuple”) is placed in a newly-created tier if the tier set is empty. Alternatively, if the tier set is not empty, the current location n-tuple is placed in the tier immediately subsequent to the most recently created tier that contains a location n-tuple that is unambiguously smaller than the current location n-tuple if any (and a new tier is created and added to the tier set if necessary for such placement). Alternatively, if no tier contains a location n-tuple that is unambiguously smaller than the current location n-tuple, the current location n-tuple is placed in the first-created tier in the tier set. For example, if location n-tuple container[n] (where n equals any integer of zero or greater) located in tier[m] (where m equals any integer of zero or greater) is unambiguously smaller than location n-tuple container[n+x] (where x equals any positive integer greater than zero) in tier[m] and tier[m] is the most recently created tier that contains a location n-tuple that is unambiguously smaller than location n-tuple container[n+x], then location n-tuple container[n+x] is placed in tier[m+1] (and a new tier is created and added to the tier set if m references the most recently created tier in the existing tier set). A location n-tuple is “unambiguously smaller” than another location n-tuple if each of the values in the component fields in the first location n-tuple are less than the values in the corresponding component fields of the second location n-tuple. Thus, location n-tuple {1, 3, 2} is unambiguously smaller than location n-tuple {2, 6, 5} since 1<2 and 3<6 and 2<5. In contrast, the location n-tuple {1, 3, 2} is not unambiguously smaller than location n-tuple {2, 6, 2} since 1<2 and 3<6 but 2=2. Likewise, location n-tuple {1, 3, 2} is not unambiguously smaller than location n-tuple {2, 6, 1} since 1<2 and 3<6 but 2>1.

FIG. 1 shows that the method 100 can include obtaining 120 the desired information regarding common subsequences. In particular, the tier set can be used to obtain any desired information regarding the common subsequences. For example, the identity and/or length of the longest common subsequence, the number of common subsequences, the identity and/or length of any common subsequences or any other desired information can be obtained as described below.

For example, the length of the longest common subsequence is equal to the number of tiers created and may be obtained if desired. E.g., if 5 tiers have been created then the longest common subsequence is exactly five items long. The actual location n-tuples within the tiers are irrelevant to the length determination. As noted above, if the length of the longest common subsequence is less than a desired minimum length then no minimum length common subsequence can exist.

In addition, if a common subsequence (or set of common subsequences if more than one) is desired it can be recovered from the tier set. Each potential common subsequence must include precisely one location n-tuple from each of one or more tiers such that the location n-tuple from each tier is unambiguously smaller than the location n-tuple from each subsequently-created tier if any (the “increasing order requirement”). That is, the location n-tuple from tier[0] is unambiguously smaller than the location n-tuple from tier[1] and the location n-tuple from tier[1] is unambiguously smaller than the location n-tuple from tier[2], and so forth for each tier. Moreover, the total number of potential common subsequences that may be identified among any set of tiers is equal to the product of the number of location n-tuples in each such tier (e.g., if there are three tiers and if tier[0] contains 2 location n-tuples, tier[1] contains 3 location n-tuples and tier[2] contains 1 location n-tuple then the total number of potential common subsequences is 2*3*1=6). One of skill in the art will appreciate that potential common subsequences may include location n-tuples from non-sequential tiers. For example, if seven tiers have been created, a potential common subsequence may be identified by selecting precisely one location n-tuple from each of the following tiers: tier[0], tier[1], tier[3], tier[5] and tier[6]. Thus, each potential common subsequence can be identified and examined to ensure that it satisfies the increasing order requirement, eliminating any that do not and thus leaving only valid common subsequences. In addition, any duplicate common subsequences may be eliminated.

Further, if the longest common subsequence set is desired then the same method as above can be used except that only any common subsequences that include precisely one location n-tuple from each tier need be identified and/or recreated.

Further, if the minimum length common subsequence set is desired then the same method as above can be used except that only any common subsequences above the minimum length need be identified and/or recreated. For example, if 7 tiers have been created and the minimum desired subsequence length is 5 items then only common subsequences which span at least 5 tiers need be identified and/or recreated.

Further, if the minimum density common subsequence set is desired then the same method as above can be used except that only common subsequences which are above the minimum density need be identified and/or recreated. The density of a common subsequence is defined as the length of the common subsequence divided by the longest distance between items (including the first and last item) in any component sequence. That is, density=L_{CS}/D=L_{CS}/IB_{FL}+2=L_{CS}/P_{LI}−P_{FI}+1 (where L_{CS} is the length of the common subsequence, D is the longest distance between items—including the first and last item—in any component sequence, IB_{FL} is the number of items between the first item and the last item, P_{LI} is the position of the last item and P_{FI} is the position of the first item). For example, if the length of the common subsequence is five items and in one component sequence the first item is at position 4 and the last item is at position 15 then the distance between items is 12 and the number of items between the first item and the last item is 10. Therefore, the density=5/12=5/(10+2)=˜0.42.

Finally, if the minimum length, minimum density common subsequence set is desired then the same method as above can be used except that only common subsequences which are above the minimum length and the minimum density need be identified and/or recreated.

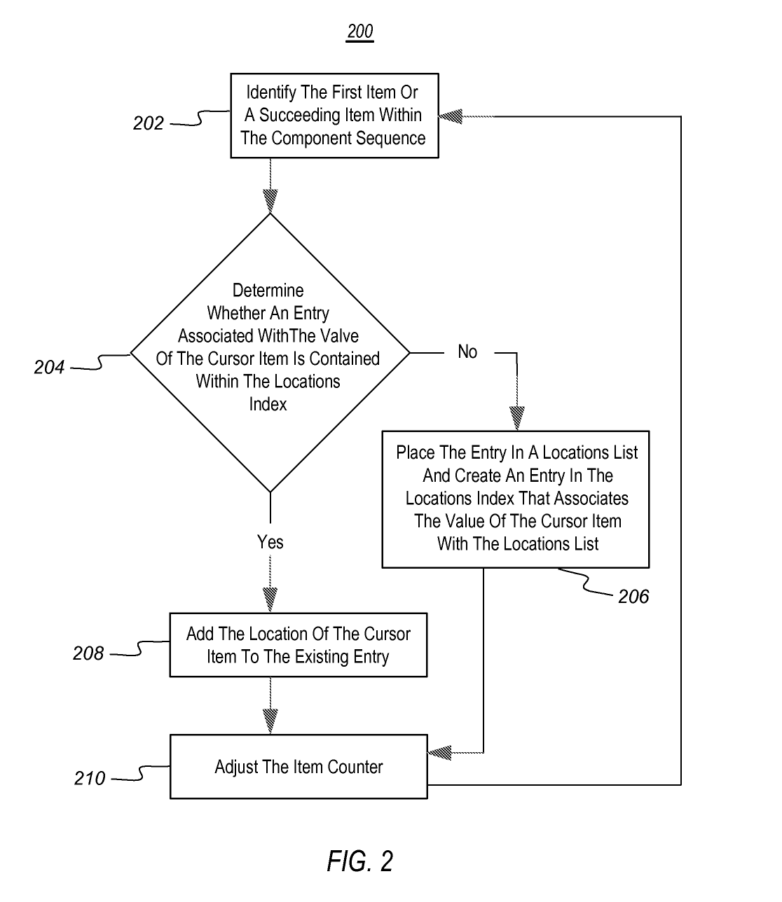

FIG. 2 is a flow chart illustrating a method 200 of identifying 110 one or more distinct items and their locations within a component sequence. The method 200 may be used as part of obtaining one or more common subsequences among an arbitrary number of sequences or for any other purpose. For example, when identifying common subsequences, the method 200 can be performed on each component sequence.

FIG. 2 shows that the method 200 can include identifying 202 either the first item or a succeeding item within the component sequence (a “cursor item”). That is, either the first item is identified, or if one or more items have been identified, subsequent items are identified. I.e., if no items have been identified 202, then the first item is identified 202. If some items within the component sequence have been identified then the item immediately following the last identified item is identified 202. Thus, each item may be iteratively identified 202. The item being identified is classified by the item counter (for example, see step 108 of FIG. 1).

FIG. 2 also shows that the method 200 can include determining 204 whether an entry associated with the current value of the cursor item is contained within the locations index. Each locations index is associated with a component sequence. I.e., it is determined whether the cursor item has been previously identified 204 within the component sequence or whether the cursor item is being identified 204 for the first time within the component sequence.

FIG. 2 further shows that the method 200 can include placing 206 the location of the cursor item in a locations list and creating an entry in the in the locations index that associates the value of the cursor item with the locations list when an entry for the current value of the cursor item does not exist in the locations index. I.e., if the entry does not exist for the current value of the cursor item, then an entry must be created for the current value of the cursor item. The locations list is then added to the location index.

FIG. 2 additionally shows that the method 200 can include adding 208 the current value of the item counter to the existing entry if an entry for the cursor item exists in the locations index.

FIG. 2 moreover shows that the method 200 can include adjusting 210 the item counter. Adjusting 210 the item counter classifies the next item to be identified, if a next item exists. For example, the value of the item counter can be incremented. Additionally or alternatively, the item counter can be adjusted to point at the next item, or a subsequent item in the component sequence. The method may be repeated until no items remain to be identified.

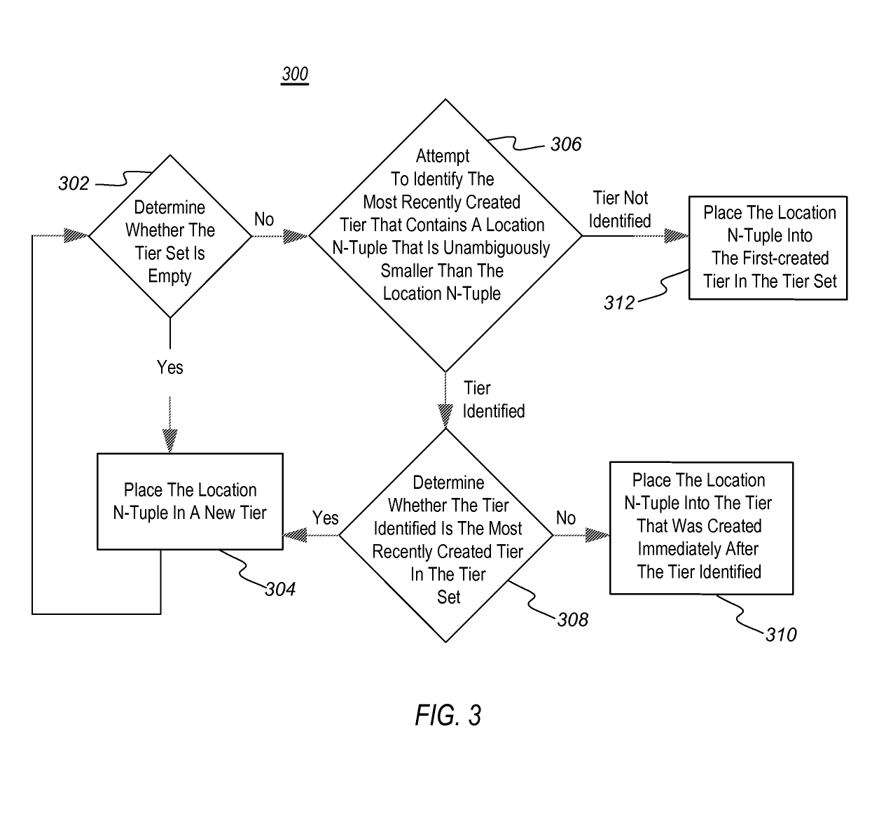

FIG. 3 is a flow chart illustrating a method 300 of placing a location n-tuple (the “location n-tuple to be placed”) into a tier in a tier set. The method 300 may be used as part of obtaining one or more common subsequences among an arbitrary number of sequences or for any other purpose. The method 300 may be performed iteratively on each of one or more location n-tuples (for example, if the location n-tuples are in location n-tuple sorted order).

FIG. 3 shows that the method 300 can include determining 302 whether the tier set is empty. That is, determining 302 whether any location n-tuple has yet been stored within the tier set. If no location n-tuple has been stored, then the tier set is empty, otherwise the tier set is not empty.

FIG. 3 also shows that the method 300 can include placing 304 the location n-tuple to be placed in a new tier when the tier set is empty. For example, the new tier can be placed in a newly created tier container. The new tier is then added to the tier set. That is, if no location n-tuple has yet been placed in the tier set then a new tier should be created, the location n-tuple to be placed should be placed in the newly-created tier and the newly-created tier should be added to the tier set.

FIG. 3 further shows that the method 300 an include attempting 310 to identify the most recently created tier that contains a location n-tuple that is unambiguously smaller than the location n-tuple to be placed when the tier set is not empty. This can include evaluating the location n-tuple to be placed against each location n-tuple in each tier in reverse order from the order in which each tier was created. For example, if three tiers have been created thus far then the location n-tuple to be placed is compared to the location n-tuples in tier[2] and then, if necessary, the location n-tuples in tier[1] and then, if necessary, the location n-tuples in tier[0].

FIG. 3 further shows that the method 300 can include determining 308 whether the most recently created tier that contains a location n-tuple that is unambiguously smaller than the location n-tuple to be placed (if such a tier has been identified) is the most recently created tier in the tier set and, if so, placing 304 the location n-tuple in a new tier.

FIG. 3 further shows that the method 300 can include placing 310 the location n-tuple to be placed into the tier that was created immediately after the most recently created tier that contains a location n-tuple that is unambiguously smaller than the location n-tuple to be placed when such a tier has been identified and such identified tier is not the most recently created tier in the tier set.

FIG. 3 further shows that the method 300 can include placing 312 the location n-tuple to be placed into the first-created tier when no tier in the tier set contains a location n-tuple that is unambiguously smaller than the location n-tuple to be placed.

Continuing the above example, if the location n-tuple to be placed is compared to a first location n-tuple in tier[2] but the first location n-tuple is not unambiguously smaller then comparisons continue. If the location n-tuple to be placed is then compared to a second location n-tuple in tier[2] and the second location n-tuple is unambiguously smaller then a new tier (tier[3]) is created, the location n-tuple to be placed is placed in tier[3], tier[3] is added to the tier set and comparisons cease. However, if none of the location n-tuples in tier[2] are unambiguously smaller than the location n-tuple to be placed then the location n-tuple to be placed is compared to the location n-tuples in tier[1] (and if then any tier[1] location n-tuple is found to be unambiguously smaller than the location n-tuple to be placed then the location n-tuple to be placed is placed in tier[2] and comparisons cease). If no tier contains a location n-tuple that is unambiguously smaller than the location n-tuple to be placed then the location n-tuple to be placed is placed in the first-created tier (tier[0] in the above example). The method may be repeated until all location n-tuples in the location n-tuple container have been placed into the tier set.

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Assume three Sequences, S1, S2 and S3 as follows:
S1: {A, X, C, A, D, F, H, I, Y, Z, J, K}
S2: {C, A, Y, D, H, F, I, X, Z, K, J, K}
S3: {A, D, C, Z, F, H, A, D, I, X, Y, J, K}

These same Sequences may alternately be depicted as follows:

| | | |
|---|---|---|
| S1[0] = A | S2[0] = C | S3[0] = A |
| S1[1] = X | S2[1] = A | S3[1] = D |
| S1[2] = C | S2[2] = Y | S3[2] = C |
| S1[3] = A | S2[3] = D | S3[3] = Z |
| S1[4] = D | S2[4] = H | S3[4] = F |
| S1[5] = F | S2[5] = F | S3[5] = H |
| S1[6] = H | S2[6] = I | S3[6] = A |
| S1[7] = I | S2[7] = X | S3[7] = D |
| S1[8] = Y | S2[8] = Z | S3[8] = I |
| S1[9] = Z | S2[9] = K | S3[9] = X |
| S1[10] = J | S2[10] = J | S3[10] = Y |
| S1[11] = K | S2[11] = K | S3[11] = J |
| | | S3[12] = K |

After a location index has been created (element 104 of FIG. 1) for each component sequence, each location index has been added to the location index set (element 106 of FIG. 1), and the locations of each distinct item in S1, S2 and S3 have been added to the location index associated with each such component sequence (element 110 of FIG. 1), the locations index set might be depicted as follows:

| Item | S1 Locations | S2 Locations | S3 Locations |
|---|---|---|---|
| D | {4} | {3} | {1, 7} |
| Z | {9} | {8} | {3} |
| C | {2} | {0} | {2} |
| Y | {8} | {2} | {10} |
| X | {1} | {7} | {9} |
| A | {0, 3} | {1} | {0, 6} |
| K | {11} | {9, 11} | {12} |
| J | {10} | {10} | {11} |
| I | {7} | {6} | {8} |
| H | {6} | {4} | {5} |
| F | {5} | {5} | {4} |

After location n-tuples have been generated for each possible combination of the locations within S1, S2 and S3 of each commonly-occurring distinct item and each such location n-tuple has been added to the location n-tuple container (element 114 of FIG. 1), the location n-tuple container might be depicted as follows: {{4, 3, 1}, {4, 3, 7}, {9, 8, 3}, {2, 0, 2}, {8, 2, 10}, {1, 7, 9}, {0, 1, 0}, {3, 1, 0}, {0, 1, 6}, {3, 1, 6}, {11, 9, 12}, {11, 11, 12}, {10, 10, 11}, {7, 6, 8}, {6, 4, 5}, {5, 5, 4}}

Because the entries in the location n-tuple container are not already in location n-tuple sorted order, they must be sorted. After the entries in the location n-tuple container are sorted (element 116 of FIG. 1) using the component field associated with S1 as the primary sort field, the component field associated with S2 as the secondary sort field and the component field associated with S3 as the tertiary sort field, the location n-tuple container might be depicted as follows: {{0, 1, 0}, {0, 1, 6}, {1, 7, 9}, {2, 0, 2}, {3, 1, 0}, {3, 1, 6}, {4, 3, 1}, {4, 3, 7}, {5, 5, 4}, {6, 4, 5}, {7,6, 8}, {8, 2, 10}, {9, 8, 3}, {10, 10, 11}, {11, 9, 12}, {11, 11, 12}}

The tier set is initially empty. After the first location n-tuple in the sorted location n-tuple container is placed (elements 302 and 304 of FIG. 3) in the tier set, the tier set might be depicted as follows:
tier 0: {{0, 1, 0}}

The second location n-tuple in the sorted location n-tuple container is then placed. Because the first location n-tuple is not unambiguously smaller than the second (since the corresponding position in S1 and S2 are the same), the second location n-tuple is placed in the same tier as the first (element 312 of FIG. 3). Thus, the tier set might now be depicted as follows:
tier 0: {{0, 1, 0}, {0, 1, 6}}

The third location n-tuple in the sorted location n-tuple container is then placed in the tier set. At this point, there exists at least one (and, in fact, two) entries in the tier set that are unambiguously smaller than the third location n-tuple and hence a most recently created tier containing an unambiguously smaller location n-tuple is identified (elements 306 and 308 of FIG. 3). This necessitates creation of another tier (element 304 of FIG. 3). After the third location n-tuple in the sorted location n-tuple container is placed in the newly-created tier and the newly-created tier is added to the tier set, the tier set might now be depicted as follows:
tier 0: {{0, 1, 0}, {0, 1, 6}}
tier 1: {{1, 7, 9}}

The fourth and fifth location n-tuples in the sorted location n-tuple container are then placed (element 312 of FIG. 3). The tier set might now be depicted as follows:
tier 0: {{0, 1, 0}, {0, 1, 6}, {2, 0, 2}, {3, 1, 0}}
tier 1: {{1, 7, 9}}

The sixth location n-tuple in the sorted location n-tuple container is then placed (element 310 of FIG. 3). The tier set might now be depicted as follows:
tier 0: {{0, 1, 0}, {0, 1, 6}, {2, 0, 2}, {3, 1, 0}}
tier 1: {{1, 7, 9}, {3, 1, 6}}

After placement of the remaining location n-tuples in the sorted location n-tuple container, the tier set might be depicted as follows:
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Because there are six entries in the tier set, the length of the longest common subsequence (S1, S2, S3) is equal to six. Notice also that the tier containing the location n-tuple {7, 6, 8} consists only of this one entry. Consequently, the item in the component sequences S1, S2 and S3 that is associated with this location n-tuple (I) is guaranteed to be included as part of the longest common subsequence. It is also guaranteed to be included as part of any common subsequence of length 4 or greater.

If the set of potential common subsequences is generated an example of a potential common subsequence that is a valid common subsequence is the following:
{{3, 1, 6}, {7, 6, 8}}

An example of a potential common subsequence that is not a valid common subsequence is the following:
{{3, 1, 6}, {6, 4, 5}}

This potential common subsequence does not satisfy the increasing order requirement because the location n-tuple {3, 1, 6} is not unambiguously smaller than the location n-tuple {6, 4, 5}.

If the set of valid longest common subsequences is generated the result might be depicted as follows:
{{{2, 0, 2}, {3, 1, 6}, {4, 3, 7}, {7, 6, 8}, {10, 10, 11}, {11, 11, 12}},
{{0, 1, 0}, {4, 3, 1}, {5, 5, 4}, {7, 6, 8}, {10, 10, 11}, {11, 11, 12}},
{{3, 1, 0}, {4, 3, 1}, {5, 5, 4}, {7, 6, 8}, {10, 10, 11}, {11, 11, 12}},
{{0, 1, 0}, {4, 3, 1}, {6, 4, 5}, {7, 6, 8}, {10, 10, 11}, {11, 11, 12}},
{{3, 1, 0}, {4, 3, 1}, {6, 4, 5}, {7, 6, 8}, {10, 10, 11}, {11, 11, 12}}}

An example of a potential longest common subsequence that is not a valid longest common subsequence is the following:
{{0, 1, 0}, {4, 3, 1}, {4, 3, 7}, {7, 6, 8}, {10, 10, 11}, {11, 11, 12}}

This potential longest common subsequence does not satisfy the increasing order requirement because the location n-tuple {4, 3, 1} is not unambiguously smaller than the location n-tuple {4, 3, 7}.

If the original sequence item longest common subsequence set is generated the result might be depicted as follows:
{{C, A, D, I, J, K},
{A, D, F, I, J, K},
{A, D, F, I, J, K},
{A, D, H, I, J, K},
{A, D, H, I, J, K}}

If the original sequence item longest common subsequence set is de-duplicated the result might be depicted as follows:
{{C, A, D, I, J, K},
{A, D, F, I, J, K},
{A, D, H, I, J, K}}

If the minimum length had been set to 5 and the set of potential minimum length common subsequences is generated an example of a valid minimum length common subsequence is the following:
{{0, 1, 0}, {4, 3, 1}, {5, 5, 4}, {7, 6, 8}, {11, 9, 12}}

An example of a potential minimum length common subsequence that is not a valid minimum length common subsequence is the following:
{{4, 3, 7}, {7, 6, 8}, {10, 10, 11}, {11, 11, 12}}

The length of this potential minimum length common subsequence does not equal or exceed the minimum length (5).

If the minimum density had been set to 0.5 and the set of potential minimum density common subsequences is generated an example of a valid minimum density common subsequence is the following:
{{3, 1, 0}, {4, 3, 1}, {5, 5, 4}}

An example of a potential minimum density common subsequence that is not a valid minimum density common subsequence is the following:
{{2, 0, 2}, {3, 1, 6}}

This potential minimum density common subsequence does not contain the requisite minimum density (0.5) with respect to sequence S3, for the following reason. The location in S3 associated with the first location n-tuple in this potential minimum density common subsequence is 2. The location in S3 associated with the last location n-tuple in this potential minimum density common subsequence is 6. The number of items between these two location n-tuples in S3 is 3. The length of this potential minimum density common subsequence (2) divided by the sum of 2 plus the number of items between (3) is equal to 0.4, which does not equal or exceed the minimum density (0.5). Thus, this potential minimum density common subsequence does not satisfy the minimum density requirement with respect to sequence S3 even though this potential minimum density common subsequence does satisfy the minimum density requirement with respect to sequences S1 and S2.

If the minimum length had been set to 5 and the minimum density had been set to 0.5 and the set of potential minimum length, minimum density common subsequences is generated an example of one valid minimum length, minimum density common subsequence is the following:
{{{2, 0, 2}, {3, 1, 6}, {4, 3, 7}, {7, 6, 8}, {10, 10, 11}, {11, 11, 12}}

An example of a potential minimum length, minimum density common subsequence that is not a valid minimum length, minimum density common subsequence set is the following:
{{3, 1, 6}, {4, 3, 7}, {7, 6, 8}, {10, 10, 11}}

The length of this potential minimum length, minimum density common subsequence (4) does not equal or exceed the requisite minimum length (5). It also does not contain the requisite minimum density (0.5) with respect to sequence S2, for the following reason. The location in S2 associated with the first location n-tuple in this potential minimum length, minimum density common subsequence is 1. The location in S2 associated with the last location n-tuple in this potential minimum length, minimum density common subsequence is 10. The number of items between these two location n-tuples in S2 is 8. The length of this potential minimum length, minimum density common subsequence (4) divided by the sum of 2 plus the number of items between (8) is equal to 0.4, which does not equal or exceed the minimum density (0.5). Thus, this potential minimum length, minimum density common subsequence does not meet the minimum density requirement with respect to sequence S2 even though this potential minimum length, minimum density common subsequence does satisfy the minimum density requirement with respect to sequences S1 and S3.

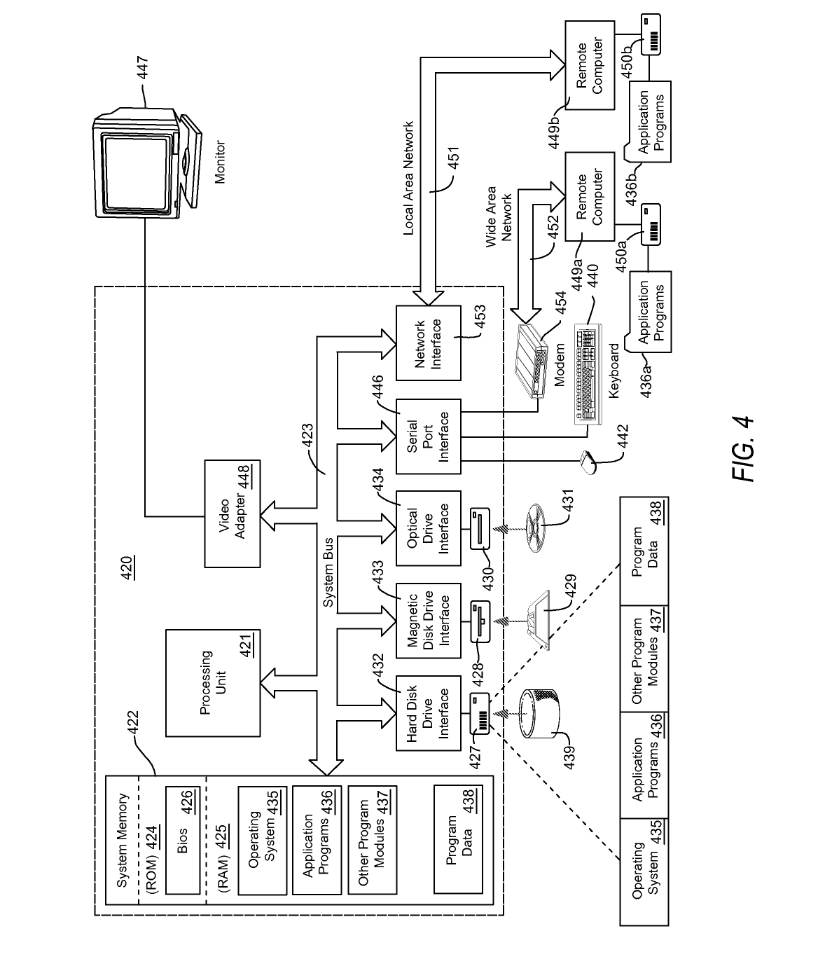

FIG. 4, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted, however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to a removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of finding common subsequences in a set of two or more component sequences, the method comprising:
obtaining two or more component sequences;
identifying the location(s) of one or more distinct items that occur at least once within each of the two or more component sequences;
placing the location(s) within each component sequence of each commonly-occurring distinct item in a location n-tuple;
storing each location n-tuple in a location n-tuple container;
sorting the entries in the location n-tuple container;
placing each of the location n-tuples in the location n-tuple container into a tier in a tier set; and
obtaining any desired information regarding common subsequences.

2. The method of claim 1, wherein the desired information regarding common subsequences includes:
the length of the longest common subsequence.

3. The method of claim 2, wherein the length of the longest common subsequence is obtained by:
determining the number of tiers within a tier set.

4. The method of claim 1, wherein the desired information regarding common subsequences includes:
recovering one or more common subsequences.

5. The method of claim 4, wherein recovering one or more common subsequences includes:
retrieving an item identified by precisely one location n-tuple from each of one or more tiers.

6. The method of claim 5, wherein the location n-tuple from each tier is unambiguously smaller than the location n-tuple from each subsequently-created tier.

7. The method of claim 1, wherein the desired information regarding common subsequences includes:
recovering one or more longest common subsequences.

8. The method of claim 1, wherein the desired information regarding common subsequences includes:
recovering one or more minimum length common subsequences.

9. The method of claim 1, wherein the desired information regarding common subsequences includes:
recovering one or more minimum density common subsequences.

10. The method of claim 1, wherein the desired information regarding common subsequences includes:
recovering one or more minimum length, minimum density common subsequences.

11. A method of finding common subsequences in a set of two or more component sequences, the method comprising:
obtaining two or more component sequences;
identifying the location(s) of one or more distinct items that occur at least once within each of the two or more component sequences, wherein identifying the location(s) of one or more distinct items that occur at least once within each of the two or more component sequences includes:
iteratively identifying each item within the component sequence;
placing a new entry for the item in a location index associated with the component sequence when the item has not been encountered previously in the component sequence; and
adding the current location of the item to an existing entry for the item in a location index associated with the component sequence when the item has been encountered previously in the component sequence;
adding one or more location indexes associated with one or more component sequences to a location index set;
using the location index set to identify the locations of one or more distinct items that occur at least once within each of the two or more component sequences;
placing the location(s) within each component sequence of each commonly-occurring distinct item in a location n-tuple;
storing each location n-tuple in a location n-tuple container;
sorting the entries in the location n-tuple container;
placing each of the location n-tuples in the location n-tuple container into a tier in a tier set; and
obtaining any desired information regarding common subsequences.

12. The method of claim 11, wherein iteratively identifying each item within the component sequence includes creating an item counter for the obtained component sequence, wherein the item counter serves to identify the location within the component sequence at which an item occurs.

13. The method of claim 12 further comprising adjusting the item counter after the location of the current item has been added to the location index.

14. The method of claim 11 further comprising that the location index set is capable of storing alias, synonym, equivalency or other information about the relationship between any two or more items.

15. A method of placing a location n-tuple into a tier in a tier set, the method comprising:
creating a new tier, placing the location n-tuple into the newly-created tier and adding the newly-created tier to the tier set when the tier set is empty;
determining the correct tier for the location n-tuple when the tier set is not empty; and
placing the location n-tuple into the correct tier.

16. The method of claim 15, wherein determining the correct tier for the location n-tuple when the tier set is not empty includes:
evaluating the location n-tuple against one or more location n-tuples in a tier.

17. The method of claim 16, wherein evaluating the location n-tuple against one or more location n-tuples in a tier includes:
determining if any of the location n-tuples in the tier is unambiguously smaller than the location n-tuple.

18. The method of claim 15, wherein determining the correct tier for the location n-tuple when the tier set is not empty includes:
identifying the most recently created tier in the tier set that contains a location n-tuple that is unambiguously smaller than the location n-tuple.

19. The method of claim 15, wherein placing the location n-tuple into the correct tier includes:
placing the location n-tuple into the first-created tier in the tier set when no tier contains a location n-tuple that is unambiguously smaller than the location n-tuple.

20. The method of claim 15, wherein placing the location n-tuple into the correct tier includes:
placing the location n-tuple into the tier that was created immediately after the most recently created tier in the tier set that contains a location n-tuple that is unambiguously smaller than the location n-tuple when the tier containing an unambiguously smaller location n-tuple is not the most recently created tier in the tier set; and
creating a new tier, placing the location n-tuple into the newly-created tier and adding the newly-created tier to the tier set when the most recently created tier in the tier set that contains a location n-tuple that is unambiguously smaller than the location n-tuple is the most recently created tier in the tier set.
